(19) United States
(12) Patent Application Publication
(10) Pub. No.: US 2014/0330556 A1
(43) Pub. Date: Nov. 6, 2014

(54) LOW COMPLEXITY REPETITION DETECTION IN MEDIA DATA

(71) Applicants: DOLBY LABORATORIES LICENSING CORPORATION, San Francisco, CA (US); DOLBY INTERNATIONAL AB, Amsterdam Zuidoost (NL)

(72) Inventors: Barbara Resch, Solna (SE); Regunathan Radhakrishnan, Foster City, CA (US); Arijit Biswas, Nuremberg (DE); Jonas Engdegard, Stockholm (SE)

(73) Assignees: DOLBY INTERNATIONAL AB, Amsterdam Zuidoost (NL); DOLBY LABORATORIES LICENSING CORPORATION, San Francisco, CA (US)

(21) Appl. No.: 14/360,257

(22) PCT Filed: Dec. 10, 2012
(86) PCT No.: PCT/US2012/068809

§ 371 Date: May 22, 2014

Related U.S. Application Data
(60) Provisional application No. 61/569,591, filed on Dec. 12, 2011.

(51) Int. Cl. G10L 19/00

(52) U.S. Cl. CPC G10L 19/00
USPC 704/221

(57) ABSTRACT

Low complexity detection of a time-wise position of a representative segment in media data is described. A subset of offset values is located in a set of offset values in media data using a first type of one or more types of features, which are extractable from (e.g., derivable from components of) the media data. The subset of offset values comprise values that are selected from the set of offset values based on one or more selection criteria. A set of candidate seed time points is identified based on the subset of offset values using a second type of the one or more types of features.

### RELATED UNITED STATES APPLICATIONS

This application claims priority to Provisional U.S. Patent Application No. 61/569,591 filed on Dec. 12, 2011, which is hereby incorporated by reference in its entirety. This application is related to Provisional U.S. Patent Application No. 61/428,578 filed on Dec. 30, 2010, Provisional U.S. Patent Application No. 61/428,588 filed on Dec. 30, 2010, and Provisional U.S. Patent Application No. 61/428,554 filed on the Dec. 30, 2010, each of which is hereby incorporated by reference in their entirety.

### TECHNOLOGY

The present invention relates generally to media. More particularly, an embodiment of the present invention relates to low complexity detection of the time-wise position of a representative segment in media data.

### BACKGROUND

Media data may comprise representative segments that are capable of making lasting impressions on listeners or viewers. For example, most popular songs follow a specific structure that alternates between a verse section and a chorus section. Usually, the chorus section is the most repeating section in a song and also the “catchy” part of a song. The position of chorus sections typically relates to the underlying song structure, and may be used to facilitate an end-user to browse a song collection.

Thus, on the encoding side, the position of a representative segment such as a chorus section may be identified in media data such as a song, and may be associated with the encoded bitstream of the song as metadata. On the decoding side, the metadata enables the end-user to start the playback at the position of the chorus section. When a collection of media data such as a song collection at a store is being browsed, chorus playback facilitates instant recognition and identification of known songs and fast assessment of liking or disliking for unknown songs in a song collection.

In a “clustering approach” (or a state approach), a song may be segmented into different sections using clustering techniques. The underlying assumption is that the different sections (such as verse, chorus, etc.) of a song share certain properties that discriminate one section from the other sections or other parts of the song.

In a “pattern matching approach” (or a sequence approach), it is assumed that a chorus is a repetitive section in a song. Repetitive sections may be identified by matching different sections of the song with one another.

Both “the clustering approach” and “the pattern matching approach” require computing a distance matrix from an input audio clip. In order to do so, the input audio clip is divided into N frames; features are extracted from each of the frames. Then, a distance is computed between every pair of frames among the total number of pairs formed between any two of the N frames of the input audio clip. The derivation of this matrix is computationally expensive and requires high memory usage, because a distance needs to be computed for each and every one of all the combinations (which means an order of magnitude of N×N times, where N is the number of frames in a song or an input audio clip therein).

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1A depicts an example basic block diagram of a media processing system, according to an embodiment of the present invention;

FIG. 1B depicts an example distance matrix, which is computed over several iterations, according to an embodiment of the present invention;

FIG. 2 depicts example media data such as a song having an offset between chorus sections, according to an example embodiment of the present invention;

FIG. 3 depicts an example distance matrix, in accordance with an example embodiment of the present invention;

FIG. 4 depicts example generation of a coarse spectrogram, according to an example embodiment of the present invention;

FIG. 5 depicts an example helix of pitches, according to an example embodiment of the present invention;

FIG. 6 depicts an example frequency spectrum, according to an example embodiment of the present invention;

FIG. 7 depicts an example comb pattern to extract an example chroma, according to an example embodiment of the present invention;

FIG. 8 depicts an example operation to multiply a frame's spectrum with a comb pattern, according to an example embodiment of the present invention;

FIG. 9 depicts a first example weighting matrix relating to a chromagram computed on a restricted frequency range, according to an example embodiment of the present invention;

FIG. 10 depicts a second example weighting matrix relating to a chromagram computed on a restricted frequency range, according to an example embodiment of the present invention;

FIG. 11 depicts a third example weighting matrix relating to a chromagram computed on a restricted frequency range, according to an example embodiment of the present invention;

FIG. 12 depicts an example chromagram plot associated with example media data in the form of a piano signal (with musical notes of gradually increasing octaves) using a perceptually motivated BPF, according to an example embodiment of the present invention;

FIG. 13 depicts an example chromagram plot associated with the piano signal as shown in FIG. 12 but using the Gaussian weighting, according to an example embodiment of the present invention;

FIG. 14 depicts an example detailed block diagram of a media processing system, according to an example embodiment of the present invention;

FIG. 15 depicts example fingerprints comprising a query sequence of fingerprints, according to an example embodiment of the present invention;

FIG. 16 depicts an example histogram of offset values, according to an example embodiment of the present invention;

FIG. 17 depicts an example feature distance matrix (chroma distance matrix), according to an example embodiment of the present invention;

FIG. 18 depicts example chroma distance values for a row of a similarity matrix, smoothed distance values and resulting seed time point for scene change detection, according to an example embodiment of the present invention;

FIG. 19A and FIG. 19B each depict example process flows according to an example embodiment of the present invention; and

FIG. 20 depicts an example hardware platform on which a computer or a computing device as described herein may be implemented, according a possible embodiment of the present invention.

### DESCRIPTION OF EXAMPLE EMBODIMENTS

Example embodiments of the present invention, which relate to low complexity repetition detection in media data, are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily including, obscuring, or obfuscating the present invention.

Example embodiments are described herein according to the following outline:
1. GENERAL OVERVIEW
2. FRAMEWORK FOR FEATURE EXTRACTION
3. SPECTRUM BASED FINGERPRINTS
4. CHROMA FEATURES
5. OTHER FEATURES
   5.1 MEL-FREQUENCY CEPSTRAL COEFFICIENTS (MFCC)
   5.2 RHYTHM FEATURES
6. DETECTION OF REPETITIVE PARTS
   6.1. FINGERPRINT MATCHING
   6.2. DETECT SIGNIFICANT (CANDIDATE) OFFSETS
   6.3. CHROMA DISTANCE ANALYSIS
   6.4. COMPUTE SIMILARITY ROWS
7. REFINEMENT USING SCENE CHANGE DETECTION
8. RANKING
9. OTHER APPLICATIONS
10. EXAMPLE PROCESS FLOW
   10.1. EXAMPLE REPETITION DETECTION PROCESS FLOW—FINGERPRINT MATCHING AND SEARCHING
   10.2. EXAMPLE REPETITION DETECTION PROCESS FLOW—HYBRID APPROACH
11. IMPLEMENTATION MECHANISMS—HARDWARE OVERVIEW
12. EQUIVALENTS, EXTENSIONS, ALTERNATIVES AND MISCELLANEOUS.

### 1. GENERAL OVERVIEW

This overview presents a basic description of some aspects of an example embodiment of the present invention. It should be noted that this overview is not an extensive or exhaustive summary of aspects of the possible embodiment. Moreover, it should be noted that this overview is not intended to be understood as identifying any particularly significant aspects or elements of the possible embodiment, nor as delineating any scope of the possible embodiment in particular, nor the invention in general. This overview merely presents some concepts that relate to the example possible embodiment in a condensed and simplified format, and should be understood as merely a conceptual prelude to a more detailed description of example embodiments that follows below.

An embodiment of the present invention provides a low complexity function to detect repetition in media data. A subset of offset values is selected from a set of offset values in media data using a first type of one or more types of features, which are extractable from the media data. The subset of offset values comprises offset values that are selected, based on one or more selection criteria, from the set of offset values. A set of candidate seed time points is identified from the subset of offset values using a second type of the one or more types of features. The first and second type of feature in this framework may in some cases differ simply in terms of time resolution. For example, a feature may be used at a lower time resolution to first quickly identify a subset of offset values at which repetitions are likely to occur. Upon identifying the subset of offset values at which repetitions are likely, a set of candidate seed time points at those selected offset values are then identified based on analysis of a higher time resolution version of the same feature. The example process may be performed with one or more computing systems, apparatus or devices, integrated circuit devices, and/or media playout, reproduction, rendering or streaming apparatus. The systems, devices, and/or apparatus and/or may be controlled, configured, programmed or directed with instructions or software, which are encoded or recorded on a computer readable storage medium.

An example embodiment may perform one or more additional repetition detection processes, which may involve somewhat more complexity. For example, in an application wherein computational costs or latency may have less significance or to achieve verification of the low complexity repetition detection, an example embodiment may further detect repetition in media with derivation (e.g., extraction) of one or more media fingerprints from component features of the media content, or with multiple (e.g., a second) offset time point subset.

As described herein, media data may comprise, but are not limited to, one or more of: songs, music compositions, scores, recordings, poems, audiovisual works, movies, or multimedia presentations. In various embodiment, the media data may be derived from one or more of: audio files, media database records, network streaming applications, media applets, media applications, media data bitstreams, media data containers, over-the-air broadcast media signals, storage media, cable signals, or satellite signals.

Media features of many different types may be extractable from the media data, capturing structural properties, tonality including harmony and melody, timbre, rhythm, loudness, stereo mix, or a quantity of sound sources of the media data. Features extractable from media data as described herein may relate to any of a multitude of media standards, a tuning system of 12 equal temperaments or a different tuning system other than a tuning system of 12 equal temperaments.

One or more of these types of media features may be used to generate a digital representation for the media data. For example, media features of a type that captures tonality, timbre, or both tonality and timbre of the media data may be extracted, and used to generate a full digital representation, for example, in time domain or frequency domain, for the media data. The full digital representation may comprise a total of N frames. Examples of a digital representation may include, but are not limited to, those of fast Fourier transforms (FFTs), digital Fourier transforms (DFTs), short time Fourier transforms (STFTs), Modified Discrete Cosine Transforms (MDCTs), Modified Discrete Sine Transforms (MDSTs), Quadrature Mirror Filters (QMFs), Complex QMFs (CQMFs), discrete wavelet transforms (DWTs), or wavelet coefficients.

Under some techniques, an N×N distance matrix may be calculated to determine whether, and wherein in the media data, a particular segment with certain representative characteristics exists in the media data. Examples of representative characteristics may include, but are not limited to, certain media features such as absence or presence of voice, repetition characteristics such as the most repeated or least repeated, etc.

In sharp contrast, under techniques as described herein, the digital representation may be reduced to fingerprints first. As used herein, fingerprints may be of a data volume several magnitudes smaller than that of the digital representation from which the fingerprints were derived and may be efficiently computed, searched, and compared.

Under techniques as described herein, a much optimized searching and matching step is used to quickly identify, for a query sequence of fingerprints, a set of offset values (or simply offsets) at which segments with certain representative characteristics are likely to repeat in the media data.

In some embodiments, some, or all, of the entire time duration of the media data may be divided into a plurality of time-wise sections each of which begins at a time point. A query sequence at a particular query time point may be formed by the sequence of fingerprints in one of the plurality of sections that begins at the particular time point—which may be called the query time point for the sequence of fingerprints.

A dynamic database of fingerprints may be used to store fingerprints of the media data to be compared with the query sequence. In an embodiment, the dynamic database of fingerprints is constructed in such a way that the fingerprints in the query sequence and additionally and/or optionally some fingerprints in the vicinity of the query sequence are excluded from the dynamic database.

A simple linear search and comparison operation may be used to determine all repeating or similar sequences of fingerprints in the dynamic database relative to the query sequence. These steps of setting a query sequence of fingerprints, constructing a dynamic database of fingerprints, and performing a linear search and comparison operation of the query sequence for similar or matched sequences in the media data may be repeated for all the time points. For each query time point (t_{q}), we record the time point (tₘ) at which the best matching sequence was found. We compute an offset value equal to (tₘ−t_{q}) which represents the time difference between the query point and its corresponding matching sequence in the database. As a result, a set of offset values that correspond to each of the query sequences may be established for the media data.

From this set of offset values, significant offset values, or a subset of offset values, may be further selected from the set of offset values based on one or more selection criteria. In an example, the one or more selection criteria may be relating to a frequency of occurrences of the offset values. The offset values associated with a frequency of occurrence that exceeds a certain threshold may be included in the subset of offset values—which may be called significant offset values. In some embodiments, the significant offset values may be identified using one or more histograms that represent frequencies of occurrences of the offset values.

Example Low Complexity Approach

In some embodiments, the significant offset values may be identified using a low-resolution representation of a distance matrix. The low-time-resolution distance matrix is computed according to the example approach described below. An embodiment functions with N feature vectors (f₁, f₂ . . . fᵢ . . . f_{N}) assumed to represent a whole song or other music content. A full distance matrix is computed from the feature vector f(i), (wherein i refers to the frame index), wherein D(o,i)=dist(f(i),f(i+o)) and wherein o represents the index for the offset value. For the subsampled distance matrix (e.g., low-time-resolution), certain frames from the feature vector are simply skipped, according to: D(o,t)=dist(f(Kt),f(Kt+o)), wherein K represents the subsampling factor represents an integer e.g. K=2, 3, 4 . . . . An embodiment is implemented in which the subsampling factor comprises 2.

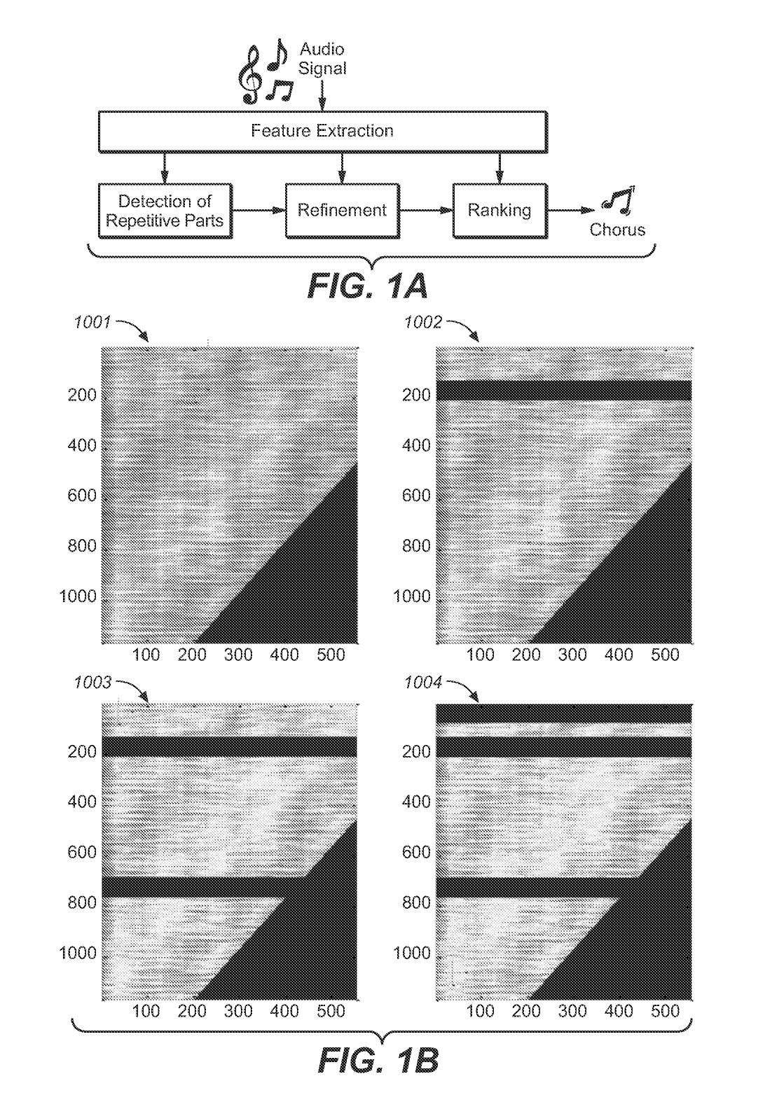

Upon computing the low-resolution distance matrix, computations are performed as described below, so as to obtain a subset of significant offsets at which repetitions occur. First, the rows of the distance matrix are smoothed (e.g. with a MA-filter of length of several seconds). Low values in the smoothed matrix correspond to audio segments of lengths that are similar to the length of the smoothing filter. The smoothed distance matrix is searched for points of local minima to find the significant offsets. An embodiment finds the minima iteratively, according to the example steps enumerated below:
1. Find the minimum value (resulting in an offset, and time value: oₘᵢₙ,n_{m,in}) dₘᵢₙ=min(D(o,i)), wherein dₘᵢₙ=D(oₘᵢₙ,n_{m,in})
2. Record the offset value as a significant offset.
3. Exclude the values around the found minima in a certain range for the next round of finding the minimum by setting: D(oₘᵢₙ±rₒ,nₘᵢₙ±rₘᵢₙ)=∞, wherein rₒ=0, 1, . . . , Rₙ, rₙ=0, 1, . . . , Nₙ. (An embodiment is implemented wherein Nₙ equals a number of frames (=number of columns of D), e.g., all the columns (time frames) of a recorded significant offset are excluded.
4. Repeat from example step 1, until the desired number of significant offsets is reached.
   An embodiment defines the number of significant offsets with a minimum number Mₘᵢₙ, a maximum number Mₘₐₓ and a threshold TH on the chroma distance value. Mₘᵢₙ or more offsets (e.g. Mₘᵢₙ=3) are obtained. A condition on the chroma-distance value is then checked to ensure that the found value is sufficiently low, e.g., up to a number of Mₘₐₓ (e.g. Mₘₐₓ=10) offsets. The threshold is determined from the global minimum value (e.g., the minimum found in first iteration), as e.g. dₘᵢₙ*1.25. This changes somewhat the example steps that are described above. For example, in an embodiment step 1. and step 4. change as follows described below.
1. The minimum value (resulting in an offset, and time value: oₘᵢₙ,n_{m,in}) is found dₘᵢₙ=min(D(o,i)), where dₘᵢₙ=D(oₘᵢₙ,n_{m,in}).
   If Mₘᵢₙ offsets are obtained, check the chroma-distance threshold: If dₘᵢₙ<TH continue on step 2., otherwise stop.
4. Repeat from step 1. (e.g., until Mₘₐₓ offsets are obtained).
   FIG. 1B depicts an example distance matrix 1000, which is computed over four (e.g., during 4) iterations, 1001, 1002, a 1003 and 1004. The detected minima are represented with the black crosses. After each iteration, the range around the previous minimum is excluded for the search in the next iteration.

Thus, an example embodiment of the present invention provides a low complexity function to detect repetition in media data. A subset of offset values is selected from a set of offset values in media data using a first type of one or more types of features, which are extractable from (e.g., derivable from components of) the media data. The subset of offset values comprise values that are selected from the set of offset values based on one or more selection criteria. A set of candidate seed time points is identified based on the subset of offset values using a second type of the one or more types of features. The example process may be performed with one or more computing systems, apparatus or devices, integrated circuit devices, and/or media playout, reproduction, rendering or streaming apparatus. The systems, devices, and/or apparatus and/or may be controlled, configured, programmed or directed with instructions or software, which are encoded or recorded on a computer readable storage medium.

An example embodiment may perform one or more additional repetition detection processes, which may involve somewhat more complexity. For example, in an application wherein computational costs or latency may have less significance or to achieve verification of the low complexity repetition detection, an example embodiment may further detect repetition in media with derivation (e.g., extraction) of one or more media fingerprints from component features of the media content, or with multiple (e.g., a second) offset time point subset.

Under the techniques described herein, feature-based comparisons or distance computations may be performed between features at a time difference equal to the significant offset values only. The whole distance matrix using N frames that cover the entire time duration of the media data as required in the existing techniques may be avoided under techniques as described herein. In some possible embodiment, the feature comparison at the significant offset values may further be performed on a restricted time range comprising time positions of time points (e.g., tm and tq) from fingerprint analysis.

In an embodiment, the feature-based comparisons or distance computations between features with time differences, which are equal to the significant offset values as described herein, may be based on a second type of feature to identify a set of candidate seed time points. The second feature type may be the same as the feature type that is used to generate the significant offset values. Alternatively and/or optionally, these feature-based comparisons or distance computations may be based on a type of feature that differs from the type of feature that was used to generate the significant offset values.

In an embodiment, the feature-based comparisons or distance computations between features with time difference equal to the significant offset values as described herein may produce similarity or dissimilarity values relating to one or more of Euclidean distances of vectors, mean squared errors, bit error rates, auto-correlation based measures, or Hamming distances. In an embodiment, filters may be applied to smooth the similarity or dissimilarity values. Examples of such filters may be, but are not limited to, a Butterworth lowpass filter, a moving average filter, etc.

In an embodiment, the filtered similarity or dissimilarity values may be used to identify a set of seed time points for each of the significant offset values. A seed time point, for example, may correspond to a local minimum or maximum in the filtered values.

Embodiments of the present invention effectively and efficiently allow identification of a chorus section, or a brief section that may be suitable for replaying or previewing when a large section of songs is being browsed, a ring tone, etc. To play any of one or more representative segments in media data such as a song, the locations of one or more representative segments in the media, for example, may be encoded by a media generator in a media data bitstream in the encoding stage. The media data bitstream may then be decoded by a media data player to recover the locations of the representative segments and to play any of the representative segments.

In an embodiment, mechanisms as described herein form a part of a media processing system, including but not limited to: a handheld device, game machine, television, laptop computer, netbook computer, cellular radiotelephone, electronic book reader, point of sale terminal, desktop computer, computer workstation, computer kiosk, or various other kinds of terminals and media processing units.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2. FRAMEWORK FOR FEATURE EXTRACTION

In an embodiment, a media processing system herein may contain four major components as shown in FIG. 1. A feature-extraction component may extract features of various types from media data such as a song. A repetition detection component may find time-wise sections of the media data that are repetitive, for example, based on certain characteristics of the media data such as the melody, harmonies, lyrics, timbre of the song in these sections as represented in the extracted features of the media data.

In an embodiment, the repetitive segments may be subjected to a refinement procedure performed by a scene change detection component, which finds the correct start and end time points that delineate segments encompassing selected repetitive sections. These correct start and end time points may comprise beginning and ending scene change points of one or more scenes possessing distinct characteristics in the media data. A pair of a beginning scene change point and an ending scene change point may delineate a candidate representative segment.

A ranking algorithm performed by a ranking component may be applied for the purpose of selecting a representative segment from all the candidate representative segments. In a particular embodiment, the representative segment selected may be the chorus of the song.

In an embodiment, a media processing system as described herein may be configured to perform a combination of fingerprint matching and chroma distance analyses. Under the techniques as described herein, the system may operate with high performance at a relatively low complexity to process a large amount of media data. The fingerprint matching enables fast and low-complexity searches for the best matching segments that are repetitive in the media data. In these embodiments, a set of offset values at which repetitions occur is identified.

An embodiment identifies a set of offset values at which repetitions occur using a first level chroma distance analysis at a lower time resolution. Then, a more accurate higher time resolution chroma distance analysis is applied only at those offsets. Relative to a same time interval of the media data, the chroma distance analysis may be more reliable and accurate than the fingerprint matching analysis but at the expense of higher complexity.

In contrast, the combined and/or hybrid (combined/hybrid) approach uses an initial low-complexity stage to identify a set of significant offset values at which repetitions occur. At this low complexity stage, an embodiment may function either using fingerprint matching to identify significant offsets or using a lower time resolution chroma distance matrix analysis. This obviates the high resolution chroma distance analysis, except as applied to certain significant offsets in the media data, with significant economy achieved in relation to computational complexity and memory usage. For example, applying the high resolution chroma distance analysis over the whole time duration of the media data has significantly more computational expense in terms of processing complexity and memory consumption.

Thus, an example embodiment of the present invention provides a low complexity function to detect repetition in media data. A subset of offset values is selected from a set of offset values in media data using a first type of one or more types of features, which are extractable from (e.g., derivable from components of) the media data. The subset of offset values comprise values that are selected from the set of offset values based on one or more selection criteria. A set of candidate seed time points is identified based on the subset of offset values using a second type of the one or more types of features. The example process may be performed with one or more computing systems, apparatus or devices, integrated circuit devices, and/or media playout, reproduction, rendering or streaming apparatus. The systems, devices, and/or apparatus and/or may be controlled, configured, programmed or directed with instructions or software, which are encoded or recorded on a computer readable storage medium.

An example embodiment may perform one or more additional repetition detection processes, which may involve somewhat more complexity. For example, in an application wherein computational costs or latency may have less significance or to achieve verification of the low complexity repetition detection, an example embodiment may further detect repetition in media with derivation (e.g., extraction) of one or more media fingerprints from component features of the media content, or with multiple (e.g., a second) offset time point subset.

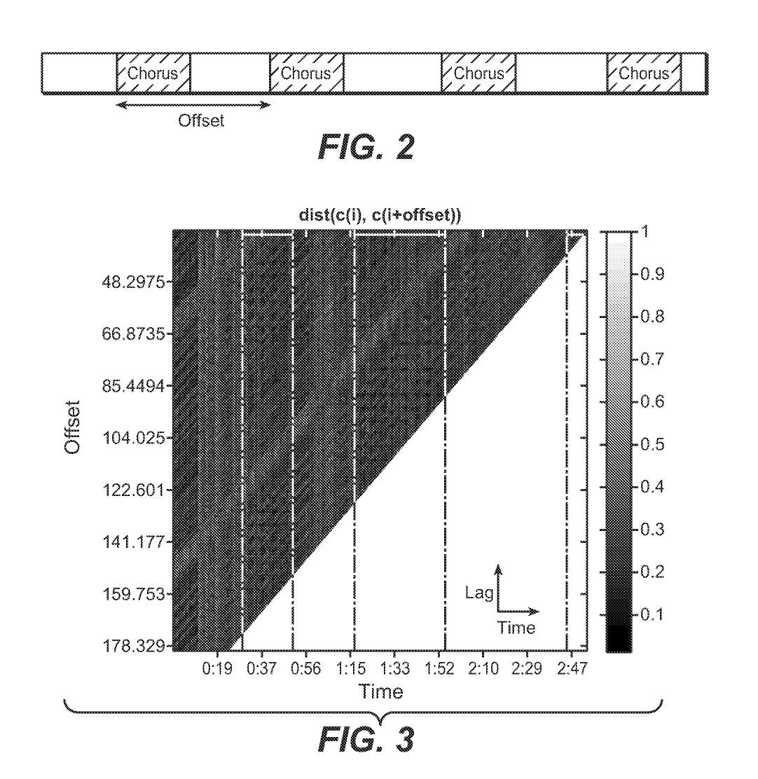

As described above, some repetition detection systems compute a full distance matrix, which contains the distance between each and every one of all combinations formed by any two of all N frames of media data. The computation of the full distance matrix may be computationally expensive and require high memory usage. FIG. 2 depicts example media data such as a song having an offset as shown between the first and second chorus sections. FIG. 3 shows an example distance matrix with two dimensions, time and offset, for distance computation. The offset denotes the time-lag between two frames from which a dissimilarity value (or a distance) relating to a features (or similarity) is computed. Repetitive sections are represented as horizontal dark lines, corresponding to a low distance of a section of successive frames to another section of successive frames that are a certain offset apart.

Under techniques as described herein, the computation of a full distance matrix may be avoided. Instead, fingerprint matching data may be analyzed to provide the approximate locations of repetitions and respective offsets between (neighboring repetitions) approximate locations. Thus, distance computations between features that are separated by an offset value that is not equal to one of the significant offsets can be avoided. In some possible embodiment, the feature comparison at the significant offset values may further be performed on a restricted time range comprising time positions of time points (tm and tq) from fingerprint analysis. In an embodiment, a lower time resolution distance matrix is computed to identify a set of significant offsets. As a result, even if a distance matrix is used under techniques as described herein, such a distance matrix may comprise only a few rows and columns for which distances are to be computed, relative to the full distance matrix under other techniques, with concomitant computational economy.

### 3. SPECTRUM BASED FINGERPRINTS

Fingerprint extraction (e.g., fingerprint derivation from content components) creates a compact bitstream representation that can serve as an identifier for an underlying section of the media data. In general, for the purpose of detecting malicious tempering of media data, fingerprints may be designed in such a way as to possess robustness against a variety of signal processing/manipulation operations including coding, Dynamic Range Compression (DRC), equalization, etc. However, for the purpose of finding repeating sections in media data as described herein, the robustness requirements of fingerprints may be relaxed, since the matching of the fingerprints occurs within the same song. Malicious attacks that must be dealt with by a typical fingerprinting system may be absent or relatively rare in the media data as described herein.

Furthermore, fingerprint extraction herein may be based on a coarse spectrogram representation. For example, in embodiments in which the media data is an audio signal, the audio signal may be down-mixed to a mono signal and may additionally and/or optionally be down sampled to 16 kHz. In some embodiments, the media data such as the audio signal may be processed into, but is not limited to, a mono signal, and may further be divided into overlapping chunks. A spectrogram may be created from each of the overlapping chunks. A coarse spectrogram may be created by averaging along both time and frequency. The foregoing operation may provide robustness against relatively small changes in the spectrogram along time and frequency. It should be noted that, In an embodiment, the coarse spectrogram herein may also be chosen in a way to emphasize certain parts of a spectrum more than other parts of the spectrum.

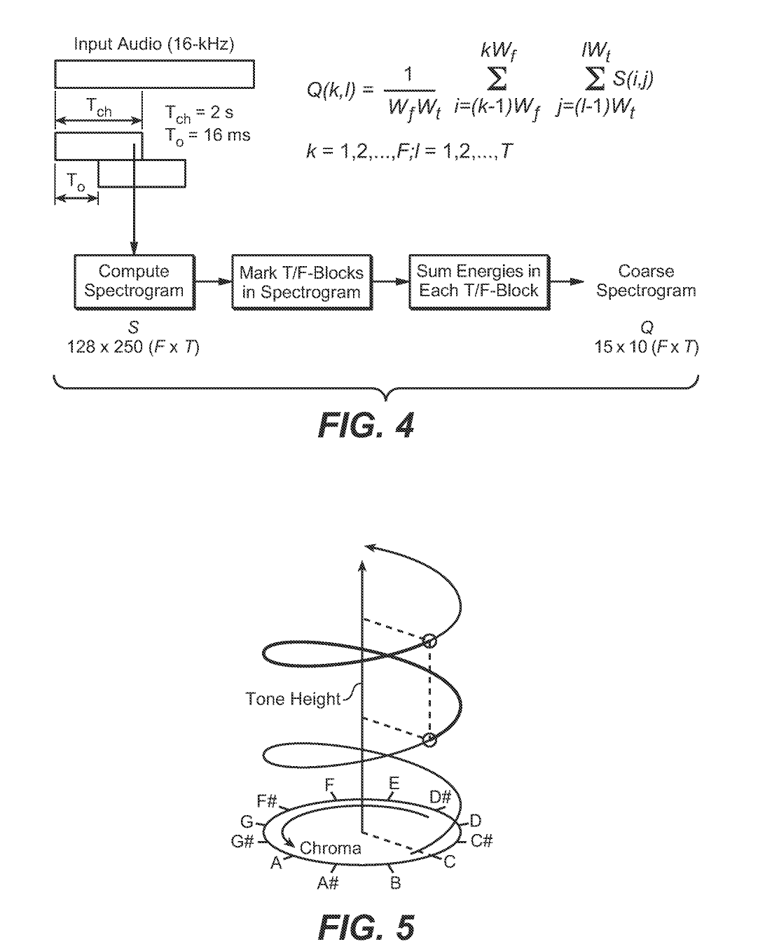

FIG. 4 depicts example generation of a coarse spectrogram according to an example embodiment of the present invention. The (input) media data (e.g., a song) is first divided into chunks of duration T_{ch}=2 seconds with a step size of Tₒ=16 milliseconds (ms). For each chunk of audio data (X_{ch}), a spectrogram may be computed with a certain time resolution (e.g., 128 samples or 8 ms) and frequency resolution (256-sample PIT). The computed spectrogram S may be tiled with time-frequency blocks. The magnitude of the spectrum within each of the time-frequency blocks may be averaged to obtain a coarse representation Q of the spectrogram S. The coarse representation Q of S may be obtained by averaging the magnitude of frequency coefficients in time-frequency blocks of size W_{f}×Wₜ. Here, W_{f} is the size of block along frequency and Wₜ is the size of block along time. Where F represents the number of blocks along frequency axis and T be the number of blocks along time axis and hence Q is of size (F*T). Q may be computed in expression (1) given below:

$$Q ( k , l ) = \frac{1}{{W}_{f} * {W}_{t}} {\sum }_{i = ( k - 1 ) {W}_{j}}^{k {W}_{f}} {\sum }_{j = ( l - 1 ) {W}_{t}}^{l {W}_{t}} S ( i , j ) \\ k = 1 , 2 … F ; l = 1 , 2 … T \qquad ( Expression 1. )$$

In Expression 1, i and j represent the indices of frequency and time in the spectrogram and k and 1 represent the indices of the time-frequency blocks in which the averaging operation is performed. In an embodiment, F may comprise a positive integer (e.g., 5, 10, 15, 20, etc.), and T may comprise a positive integer (e.g., 5, 10, 15, 20, etc.).

In an embodiment, a low-dimensional representation of the coarse representation (Q) of spectrogram of the chunk may be created by projecting the spectrogram onto pseudo-random vectors. The pseudo-random vectors may be thought of as basis vectors. A number K of pseudo-random vectors may be generated, each of which may be with the same dimensions as the matrix Q (F×T). The matrix entries may be uniformly distributed random variables in [0, 1]. The state of the random number generator may be set based on a key. The pseudo-random vectors may be denoted as P₁, P₂, . . . P_{K}, each of dimension (F×T). The mean of each matrix Pᵢ may be computed. Each matrix element in Pᵢ (i goes from 1 to K) may be subtracted with the mean of matrix Pᵢ. Then, the matrix Q may be projected onto these K random vectors as shown in Expression 2, below:

$${H}_{k} = {\sum }_{i = 1}^{M} {\sum }_{j = 1}^{N} Q ( i , j ) * {P}_{k} ( i , j ) \qquad ( Expression 2. )$$

In Expression 2, Hₖ represents the projection of the matrix Q onto the random vector Pₖ. Using the median of these projections (Hₖ, k=1, 2, . . . K) as a threshold, a number K of hash bits for the matrix Q may be generated. For example, a hash bit ‘1’ may be generated for kth hash bit if the projection Hₖ is greater than the threshold. Otherwise, a hash bit of ‘0’ if not. In an embodiment, K may be a positive integer such as 8, 16, 24, 32, etc. In an example, a fingerprint of 24 hash bits as described herein may be created for every 16 ms of audio data. A sequence of fingerprints comprising these 24-bit codewords may be used as an identifier for that particular chunk of audio that the sequence of fingerprints represents. In an embodiment, the complexity of fingerprint extraction as described herein may be about 2.58 MIPS.

A coarse representation Q herein has been described as a matrix derived from FFT coefficients. It should be noted that this is for illustration purposes only. Other ways of obtaining a representation in various granularities may be used. For example, different representations derived from fast Fourier transforms (FFTs), digital Fourier transforms (DFTs), short time Fourier transforms (STFTs), Modified Discrete Cosine Transforms (MDCTs), Modified Discrete Sine Transforms (MDSTs), Quadrature Mirror Filters (QMFs), Complex QMFs (CQMFs), discrete wavelet transforms (DWTs), or wavelet coefficients, chroma features, or other approaches may be used to derive codewords, hash bits, fingerprints, and sequences of fingerprints for chunks of the media data.

### 4. CHROMA FEATURES

As used herein, the term chromagram may relate to an n-dimensional chroma vector. For example, for media data in a tuning system of 12 equal temperaments, a chromagram may be defined as a 12-dimensional chroma vector in which each dimension corresponds to the intensity (or alternatively magnitude) of a semitone class (chroma). Different dimensionalities of chroma vectors may be defined for other tuning systems. The chromagram may be obtained by mapping and folding an audio spectrum into a single octave. The chroma vector represents a magnitude distribution over chromas that may be discretized into 12 pitch classes within an octave. Chroma vectors capture melodic and harmonic content of an audio signal and may be less sensitive to changes in timbre than the spectrograms as discussed above in connection with fingerprints that were used for determining repetitive or similar sections.

Chroma features may be visualized by projecting or folding on a helix of pitches as illustrated in FIG. 5. The term “chroma” refers to the position of a musical pitch within a particular octave; the particular octave may correspond to a cycle of the helix of pitches, as viewed from sideways in FIG. 5. Essentially, a chroma refers to a position on the circumference of the helix as seen from directly above in FIG. 5, without regard to heights of octaves on the helix of FIG. 5. The term “height”, on the other hand, refers to a vertical position on the circumference of the helix as seen from the side in FIG. 5. The vertical position as indicated by a specific height corresponds to a position in a specific octave of the specific height.

The presence of a musical note may be associated with the presence of a comb-like pattern in the frequency domain. This pattern may be composed of lobes approximately at the positions corresponding to the multiples of the fundamental frequency of an analyzed tone. These lobes are precisely the information which may be contained in the chroma vectors.

In an embodiment, the content of the magnitude spectrum at a specific chroma may be filtered out using a band-pass filter (BPF). The magnitude spectrum may be multiplied with a BPF (e.g., with a Hann window function). The center frequencies of the BPF as well as the width may be determined by the specific chroma and a number of height values. The window of the BPF may be centered at a Shepard's frequency as a function of both chroma and height. An independent variable in the magnitude spectrum may be frequency in Hz, which may be converted to cents (e.g., 100 cents equals to a half-tone). The fact that the width of the BPF is chroma specific stems from the fact that musical notes (or chromas as projected onto a particular octave of the helix of FIG. 5) are not linearly spaced in frequency, but logarithmically. Higher pitched notes (or chromas) are further apart from each other in the spectrum than lower pitched notes, so the frequency intervals between notes at higher octaves are wider than those at lower octaves. While the human ear is able to perceive very small differences in pitch at low frequencies, the human ear is only able to perceive relatively significant changes in pitch at high frequencies. For these reasons related to human perception, the BPF may be selected to be of a relatively wide window and of a relatively large magnitude at relatively high frequencies. Thus, In an embodiment, these BPF filters may be perceptually motivated.

A chromagram may be computed by a short-time-Fourier-transformation (STFT) with a 4096-sample Hann window. In an embodiment, a fast-Fourier-transform (FFT) may be used to perform the calculations; a FFT frame may be shifted by 1024 samples, while a discrete time step (e.g., 1 frame shift) may be 46.4 (or simply denoted as 46 herein) milliseconds (ms).

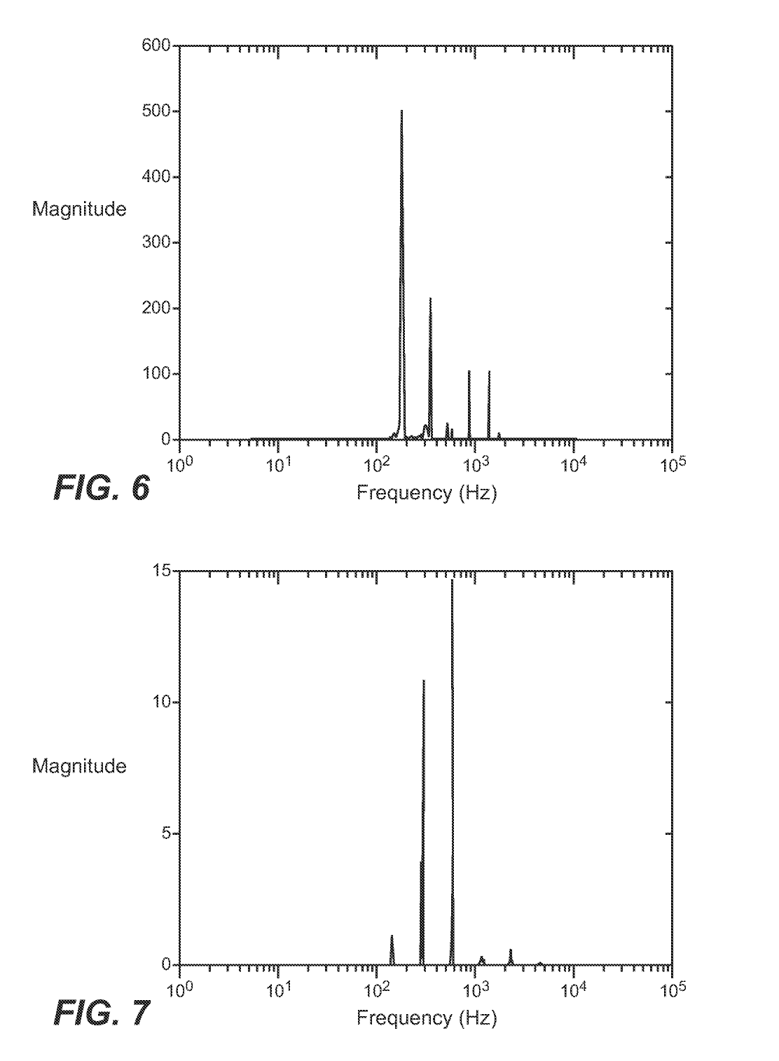

First, the frequency spectrum (as illustrated in FIG. 6) of a 46 ms frame may be computed. Second, the presence of a musical note may be associated with a comb pattern in the frequency spectrum, composed of lobes located at the positions of the various octaves of the given note. The comb pattern may be used to extract, e.g., a chroma D as shown in FIG. 7. The peaks of the comb pattern may be at 147, 294, 588, 1175, 2350, and 4699 Hz.

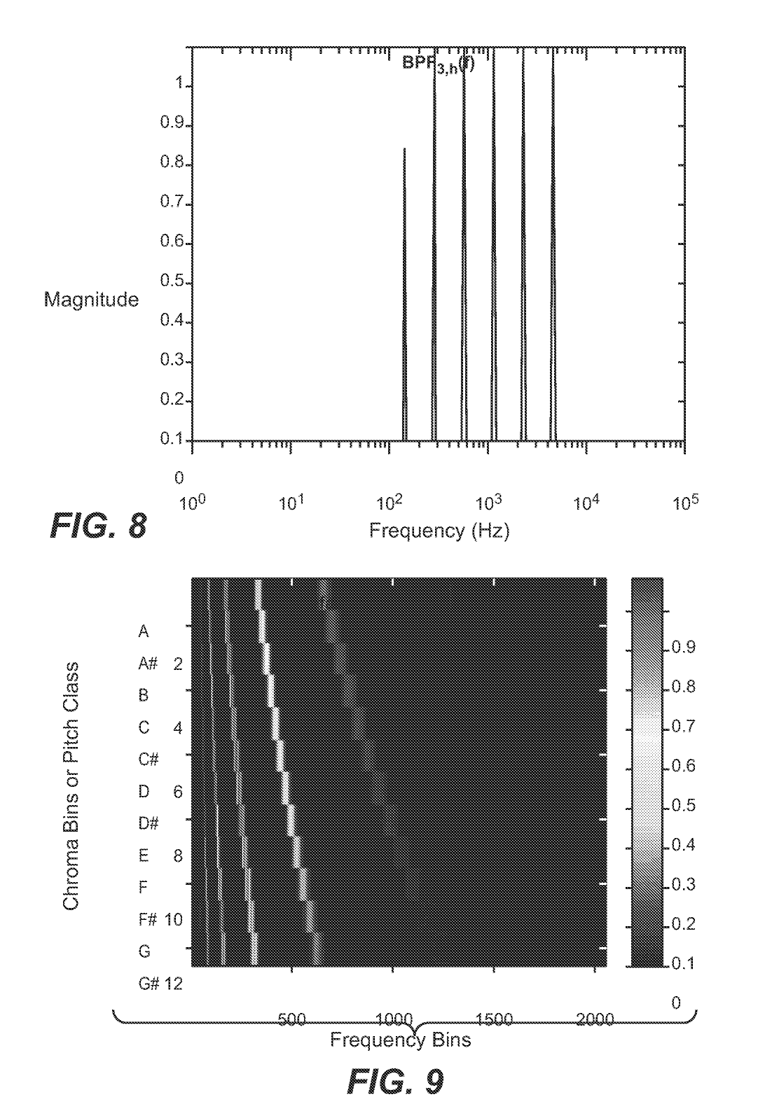

Third, to extract the chroma D from a given frame of a song, the frame's spectrum may be multiplied with the above comb pattern. The result of the multiplication is illustrated in FIG. 8, and represents all the spectral content needed for the calculation of the chroma D in the chroma vector of this frame. The magnitude of this element is then simply a summation of the spectrum along the frequency axis.

Fourth, to calculate the remaining 11 chromas the system herein may generate the appropriate comb patterns for each of the chromas, and the same process is repeated on the original spectrum.

In an embodiment, a chromagram may be computed using Gaussian weighting (on a log-frequency axis; which may, but is not limited to, be normalized). The Gaussian weighting may be centered at a log-frequency point, denoted as a center frequency “f_ctr”, on the log-frequency axis. The center frequency “f_ctr” may be set to a value of ctroct (in units of octaves or cents/1200, with the referential origin at A0), which corresponds to a frequency of 27.5*(2̂ctroct) in units of Hz. The Gaussian weighting may be set with a Gaussian half-width of f_sd, which may be set to a value of octwidth in units of octaves. For example, the magnitude of the Gaussian weighting drops to exp(−0.5) at a factor of 2̂octwidth above and below the center frequency f_ctr. In other words, In an embodiment, instead of using individual perceptually motivated BPFs as previously described, a single Gaussian weighting filter may be used.

Thus, for ctroct=5.0 and octwidth=1.0, the peak of the Gaussian weighting is at 880 Hz, and the weighting falls to approximately 0.6 at 440 Hz and 1760 Hz. In various example embodiments, the parameters of the Gaussian weighting may be preset, and additionally and/or optionally, configurable by a user manually and/or by a system automatically. In an embodiment, a default setting of ctroct=5.1844 (which gives f_ctr=1000 Hz) and octwidth=1 may be present or configured. Thus, the peak of the Gaussian weighting for this example default setting is at 1000 Hz, and the weighting falls to approximately 0.6 at 500 and 2000 Hz.

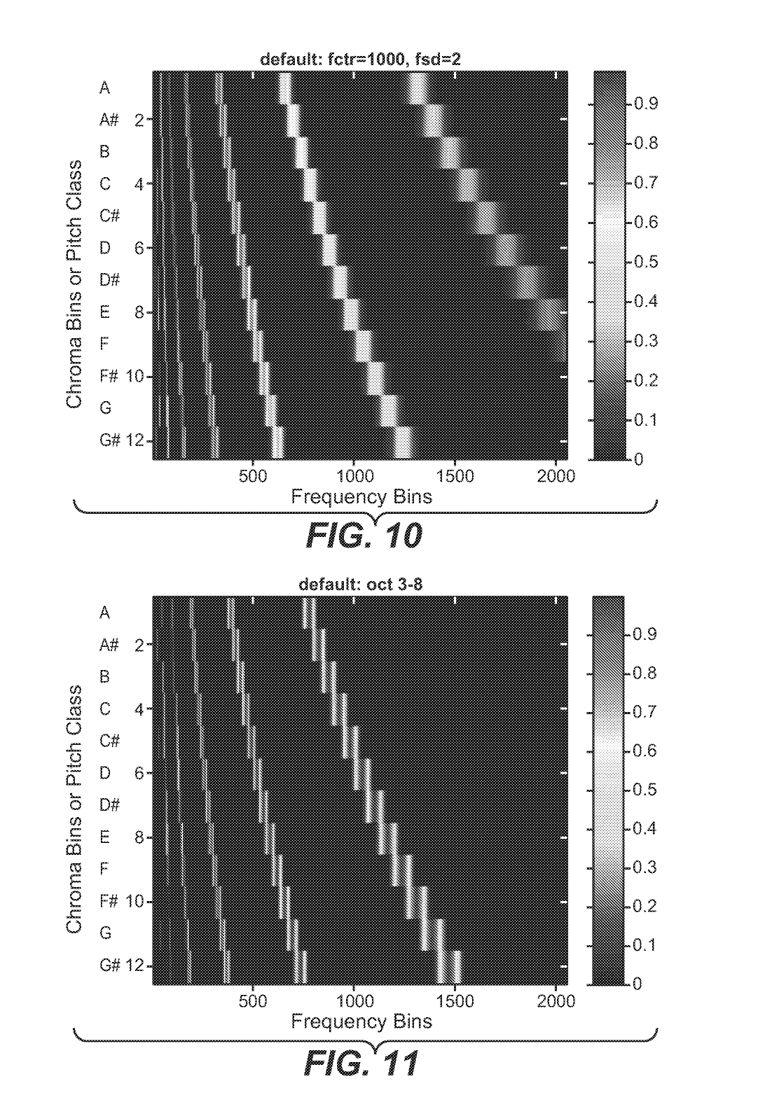

Thus, in these embodiments, the chromagram herein may be computed on a rather restricted frequency range. This can be seen from the plots of a corresponding weighting matrix as illustrated in FIG. 9. If the f_sd of the Gaussian weighting is increased to 2 in units of octaves, the spread of the weighting for the Gaussian weighting is also increased. The plot of a corresponding weighting matrix looks as shown in FIG. 10. As a comparison, the weighting matrix looks as shown in FIG. 11 when operating with an f_sd having a value of 3 to 8 octaves.

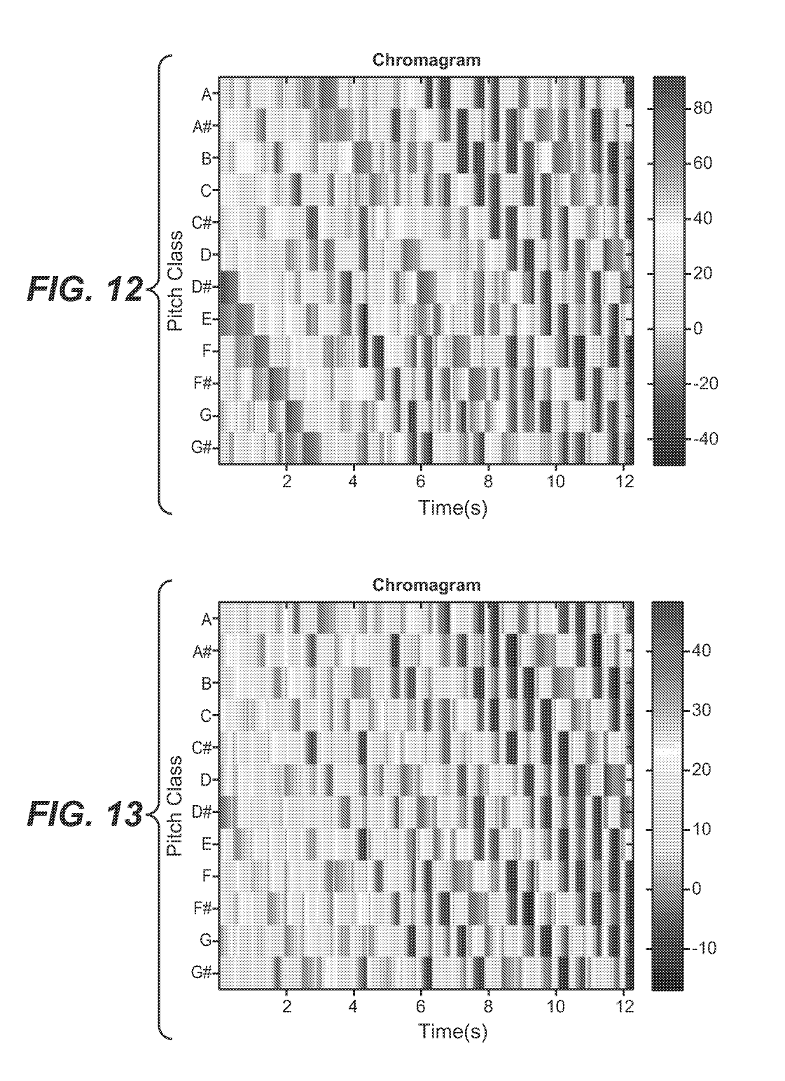

FIG. 12 depicts an example chromagram plot associated with example media data in the form of a piano signal (with musical notes of gradually increasing octaves) using a perceptually motivated BPF. In comparison, FIG. 13 depicts an example chromagram plot associates with the same piano signal using the Gaussian weighting. The framing and shift is chosen to be exactly same for the purposes of making comparison between the two chromagram plots.

The patterns in both chromagram plots look similar. A perceptually motivated band-pass filter may provide better energy concentration and separation. This is visible for the lower notes, where the notes in the chromagram plot generated by the Gaussian weighting look hazier. While the different BPFs may impact chord recognition applications differently, a perceptually motivated filter brings little added benefits for segment (e.g., chorus) extraction.

In an embodiment, the chromagram and fingerprint extraction as described herein may operate on media data in the form of a 16-kHz sampled audio signal. Chromagram may be computed with STFT with a 3200-sample Hann window using FFT. A FFT frame may be shifted by 800 samples with a discrete time step (e.g., 1 frame shift) of 50 ms. It should be noted that other sampled audio signals may be processed by techniques herein. Furthermore, for the purpose of the present invention, a chromagram computed with a different transform, a different filter, a different window function, a different number of samples, a different frame shift, etc. is also within the scope of the present invention.

### 5. OTHER FEATURES

Techniques herein may use various features that are extracted from the media data such as MFCC, rhythm features, and energy described in this section. As previously noted, some, or all, of extracted features as described herein may also be applied to scene change detection. Additionally and/or optionally, some, or all, of these features may also be used by the ranking component as described herein.

### 5.1 MEL-FREQUENCY CEPSTRAL COEFFICIENTS (MFCC)

Mel-frequency Cepstral coefficients (MFCCs) aim at providing a compact representation of the spectral envelope of an audio signal. The MFCC features may provide a good description of the timbre and may also be used in musical applications of the techniques as described herein.

### 5.2 RHYTHM FEATURES

Some algorithmic details of computing the rhythmic features may be found in Hollosi, D., Biswas, A., “Complexity Scalable Perceptual Tempo Estimation from HE-AAC Encoded Music,” in 128^{th} AES Convention, London, UK, 22-25 May 2010, the entire contents of which is hereby incorporated by reference as if fully set forth herein. In an embodiment, perceptual tempo estimation from HE-AAC encoded music may be carried out based on modulation frequency. Techniques herein may include a perceptual tempo correction stage in which rhythmic features are used to correct octave mors. An example procedure for computing the rhythmic features may be described as follows.

In the first step, a power spectrum is calculated; a Mel-Scale transformation is then performed. This step accounts for the non-linear frequency perception of the human auditory system while reducing the number of spectral values to only a few Mel-Bands. Further reduction of the number of bands is achieved by applying a non-linear companding function, such that higher Mel-bands are mapped into single bands under the assumption that most of the rhythm information in the music signal is located in lower frequency regions. This step shares the Mel filter-bank used in the MFCC computation.

In the second step, a modulation spectrum is computed. This step extracts rhythm information from media data as described herein. The rhythm may be indicated by peaks at certain modulation frequencies in the modulation spectrum. In an example embodiment, to compute the modulation spectrum, the companded Mel power spectra may be segmented into time-wise chunks of 6 s length with certain overlap over the time axis. The length of the time-wise chunks may be chosen from a trade-off between costs and benefits involving computational complexity to capture the “long-time rhythmic characteristics” of an audio signal. Subsequently, an FFT may be applied along the time-axis to obtain a joint-frequency (modulation spectrum: x-axis—modulation frequency and y-axis—companded Mel-bands) representation for each 6 s chunk. By weighting the modulation spectrum along the modulation frequency axis with a perceptual weighting function obtained from analysis of large music datasets, very high and very low modulation frequencies may be suppressed (such that meaningful values for the perceptual tempo correction stage may be selected).

In the third step, the rhythmic features may then be extracted from the modulation spectrum. The rhythmic features that may be beneficial for scene-change detection are: rhythm strength, rhythm regularity, and bass-ness. Rhythm strength may be defined as the maximum of the modulation spectrum after summation over companded Mel-bands. Rhythm regularity may be defined as the mean of the modulation spectrum after normalization to one. Bass-ness may be defined as the sum of the values in the two lowest companded Mel-bands with a modulation frequency higher than one (1) Hz.

### 6. DETECTION OF REPETITIVE PARTS

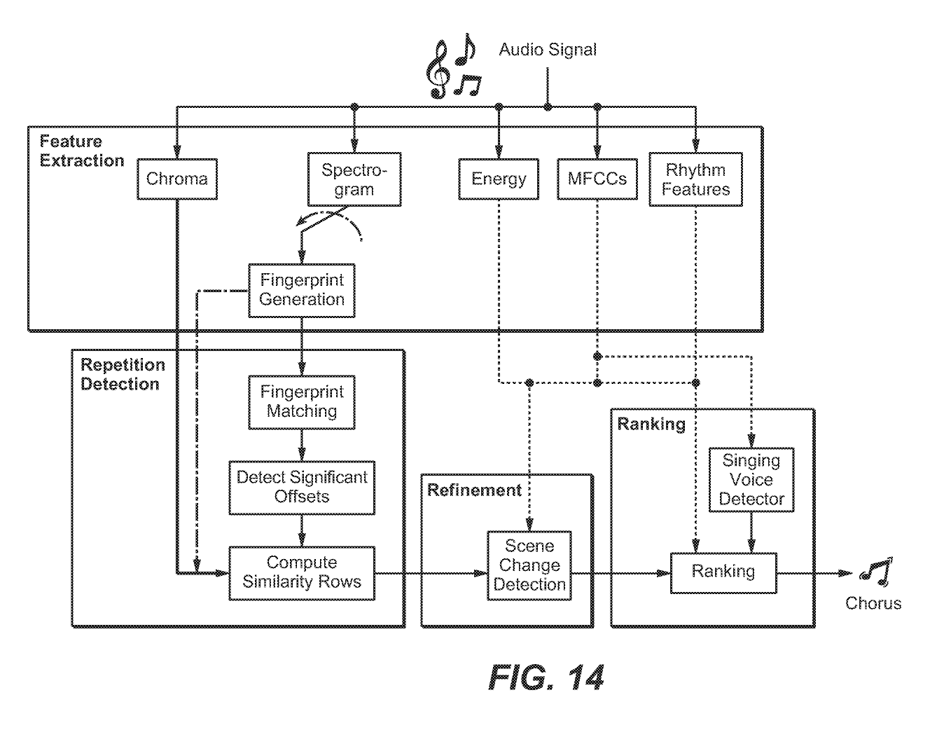

In an embodiment, repetition detection (or detection of repetitive parts) as described herein may be based on both fingerprints and chroma features. In an embodiment, initially, fingerprint queries using a tree-based search may be performed, identifying the best match for each segment of the audio signal thereby giving rise to one or more best matches. Subsequently, the data from the best matches may be used to determine offset values where repetitions occur and the corresponding rows of a chroma distance matrix are computed and further analyzed. FIG. 14 depicts an example detailed block diagram of the system, and depicts how the extracted features are processed to detect the repetitive sections.

### 6.1. FINGERPRINT MATCHING

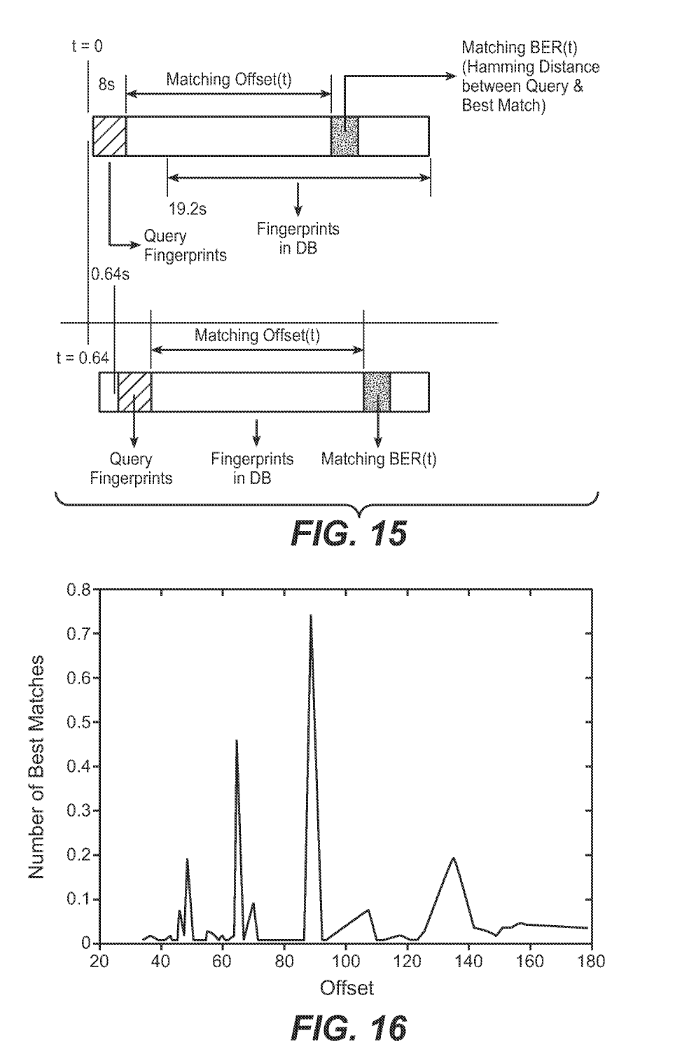

In an embodiment, using techniques as described herein, the fingerprint matching block of FIG. 14 may quickly identify offset values or time lags at which repeating segments appear in media data such as an input song. In an embodiment, as illustrated in FIG. 15, for every 0.64 s time increment (which begins at a start time point=0 initially and thereafter increments by 0.64 s) of the song, a sequence of 488 24-bit fingerprint codewords corresponding to an 8 s time interval (beginning at the start time point of each 0.64 s increment) of the song may be used as a query sequence of fingerprints. A matching algorithm may be used to find the best match for this query sequence comprising a number of fingerprint bits (e.g., 488 24-bit fingerprint codewords) in the rest of fingerprint bits (corresponding to the remaining time duration excluding the query sequence of fingerprints) of the song.

More specifically, In an embodiment, at a start time point (e.g., t=0, 0.64 s, 1.28 s, . . . etc.), a query sequence of fingerprint codewords covering a 8 s interval (which starts from, e.g., t=0, 0.64 s, 1.28 s, . . . , etc.) of the song may be used to interrogate the rest of fingerprints in a dynamic database of fingerprints. The best matching sequence of bits may be found from this dynamic database of fingerprint bits that stores the remaining fingerprint bits of the song excluding certain portions of fingerprints of the song. An optimization may be made to increase the robustness in that the dynamic database of fingerprints may exclude a portion of fingerprints that corresponds to a certain time interval from the (current) start time point of the query sequence. This optimization can be applied when the assumption can be made that the segment to be detected is repeated after a certain minimum offset. The optimization avoids the detection of repetitions that occur with smaller offsets (e.g., musical patterns repeat with only a few seconds offset). For example, an optimization may be made so that the dynamic database of fingerprints may exclude a portion of fingerprints that corresponds to a (˜20 s) 19.2 s time interval from the (current) start time point of the query sequence. When the next start time point, t=0.64 s, is set to be the current start time point, the fingerprints corresponding to 0.64 s to 8.64 s of the song may be used as a query. The dynamic database of fingerprints may now exclude the time interval of the song corresponding to (0.64 s to 19.84 s). In an embodiment, the portion of fingerprints corresponding to the time interval between the previous start time point and the current start time point (e.g., 0 to 0.64 s) may be added to the dynamic database of fingerprints. At each current start time point, the dynamic database is thus updated and a search is performed to find the best matching sequence of bits for a query sequence of fingerprint bits starting from the current start time point. For each search, the following two results may be recorded:
the offset at which the best matching section is found; and
the hamming distance between the query sequence and the best matching section from the dynamic database.

In an embodiment, a search relating to a query sequence of fingerprints as described herein may be performed efficiently using a 256-ary tree data structure and may be able to find approximate nearest neighbors in high-dimensional binary spaces. The search may also be performed using other approximate nearest neighbor search algorithms such as LSH (Locality Sensitive Hashing), minHash, etc.

### 6.2. DETECT SIGNIFICANT (CANDIDATE) OFFSETS

The fingerprint matching block of FIG. 14 returns the offset value of the best-matching segment in a song for every 0.64 s increment in the song. In an embodiment, the detect-significant-offsets block of FIG. 14 may be configured to determine a number of significant values by computing a histogram based on all offset values obtained in the fingerprint matching block of FIG. 14. FIG. 16 shows an example histogram of offset values. The significant offset values may be selected offset values for which there are a significant number of matches. The significant offset values may manifest as peaks in the histogram. In an embodiment, significant offset values are offset values with a significant number of matches. Peak detection may be based on adaptive threshold in the histogram; offset values comprising peaks above the threshold may be identified significant offset values. In some embodiments, neighboring (e.g., within a window of ˜1 s) significant offsets may be merged.

Example Low-Complexity Computation

Additionally or alternatively, an embodiment computes the significant offsets based on a lower time resolution distance matrix. The low-time-resolution distance matrix is computed as described below. An embodiment functions with an assumption that a positive whole number N of feature vectors (f₁, f₂, . . . fᵢ . . . f_{N}) represent a whole song or other musical content. The

full distance matrix is computed from the feature vector f(i), wherein i represents the frame index, according to: D(o,i)=dist(f(i),f(i+o)) wherein o represents the index for the offset value. For the subsampled distance matrix (low-time-resolution), certain frames from the feature vector are simply skipped. For example, D(o,t)=dist(f(Kt),f(Kt+O)), wherein K represents the integer subsampling factor, e.g. K=2, 3, 4 . . . . An embodiment is implemented wherein the subsampling factor comprises two (2).

Upon computing the low-resolution distance matrix, a subset of significant offsets at which repetitions occur is obtained. The rows of the distance matrix are smoothed (e.g. with a MA-filter of several seconds length). Low values in the smoothed matrix correspond to audio segments that are similar to the length of the smoothing filter. The smoothed distance matrix is searched for points of local minima to identify the significant offsets. An embodiment functions to find the local minima iteratively, as with the example process steps described below.
1. Find the minimum value (e.g., resulting in an offset, and time value: oₘᵢₙ,n_{m,in}) dₘᵢₙ=min(D(o,i)), where dₘᵢₙ=D(oₘᵢₙ,n_{m,in})
2. Record the offset value as significant offset.
3. Exclude the values around the found minima in a certain range for the next round of finding the minimum by setting: D(oₘᵢₙ±rₒ,nₘᵢₙ±rₙ)=∞, wherein rₒ=0, 1, . . . , Rₙ, r_{b}=0, 1, . . . , Nₙ. An embodiment is implemented wherein a positive whole number Nₙ equals the number of frames (e.g., equals the number of columns of the matrix D). Thus for example, all the columns (time frames) of a recorded significant offset are excluded.
4. Repeat from step 1. until the desired number of significant offsets is reached.
   The number of significant offsets in an embodiment is defined with a minimum number Mₘᵢₙ, a maximum number Mₘₐₓ and a threshold TH on the chroma distance value. A positive whole number Mₘᵢₙ or more of offsets (e.g. Mₘᵢₙ=3) are obtained. A condition on the chroma-distance value is checked to ensure that the found value is sufficiently low, up to a positive whole number of Mₘₐₓ (e.g. Mₘₐₓ=10) offsets. The threshold is determined from the global minimum value (e.g., minimum found in first iteration), as e.g. dₘᵢₙ*1.25. Step 1. and 4. change as described below.
1. Find the minimum value (resulting in an offset, and time value: oₘᵢₙ,n_{m,in}) dₘᵢₙ=min(D(o,i)), where dₘᵢₙ=D(oₘᵢₙ,n_{m,in}).
   If Mₘᵢₙ offsets are obtained, check the chroma-distance threshold: If dₘᵢₙ<TH continue on step 2., otherwise stop.
4. Repeat from step 1. (until Mₘₐₓ offsets are obtained)
   Again with reference to FIG. 1B, the distance matrix 1000 is shown during four (4) iterations: 1001, 1002, 1003 and 1004, wherein the detected minima are denoted by black crosses. After each iteration, the range around the previous minimum is excluded for the search in the next iteration.

Thus, an embodiment of the present invention functions to detect repetition in media data with low complexity. A subset of offset values is selected from a set of offset values in media data using a first type of one or more types of features, which are extractable from the media data. The subset of offset values comprise values that are selected from the set of offset values based on one or more selection criteria. A set of candidate seed time points is identified from the subset of offset values using a second type of the one or more types of features. In this context, a first type of feature corresponds to lower time resolution chroma features and the second type of feature corresponds to higher time resolution chroma features. An embodiment uses a higher resolution chroma distance analysis to detect candidate seed time point, as discussed in Section 6.3, below. The higher time resolution chroma features are used to identify candidate seed time points at selected subset of offset values. This results in an implementation that is both efficient in memory usage as well as computational expense. The example process may be performed with one or more computing systems, apparatus or devices, integrated circuit devices, and/or media playout, reproduction, rendering or streaming apparatus. The systems, devices, and/or apparatus and/or may be controlled, configured, programmed or directed with instructions or software, which are encoded or recorded on a computer readable storage medium.

An example embodiment may perform one or more additional repetition detection processes, which may involve somewhat more complexity. For example, in an application wherein computational costs or latency may have less significance or to achieve verification of the low complexity repetition detection, an example embodiment may further detect repetition in media with derivation (e.g., extraction) of one or more media fingerprints from component features of the media content, or with multiple (e.g., a second) offset time point subset. Example such embodiments, such may involve as high resolution chroma distance analysis are discussed below

### 6.3. HIGH RESOLUTION CHROMA DISTANCE ANALYSIS FOR DETECTING CANDIDATE SEED TIME POINTS

Once a number of significant offset values at which repetitive elements or sections in the media data (such as a song) is determined to occur, these selected offset values may be used to compute selective rows of a feature distance matrix (e.g., features relating to structural properties, tonality including harmony and melody, timbre, rhythm, loudness, stereo mix, or a quantity of sound sources of corresponding sections in the media data) as follows:

D(i,oₖ)=d(f(i),f(i+oₖ))

Here f(i) represents a feature vector for media data frame i and d( ) is a distance measure used to compare two feature vectors. Here oₖ is the k^{th} significant offset value. The computation of D( ) may be made for all N media frames against each of the selected offset value oₖ. The number of selected offset values oₖ is associated with how frequent a representative segment repeats in the media data, and may not vary with how many (e.g., the number N) media frames one chooses to cover the media data. Thus, the complexity of computing D( ) for all the selected offset values oₖ against all the N media frames under the techniques herein is O(N). In comparison, the complexity of a full N×N distance matrix computation under other techniques would be O(N²). Additionally, the feature distance matrix under techniques described herein is much smaller than a full N×N distance matrix, requiring much less memory space to perform the computation.

In some embodiments, the features used to compute the feature distance matrix may be, but are not limited to, one or more of the following:
features that represent timbre (e.g., MFCC);
features that represent melody (e.g., chromagrams);
features that represent rhythm; or
fingerprints derived from the song during matching.

In an embodiment, techniques described herein use one or more suitable distance measures to compare the selected features for the feature distance matrix. In an example, if the system herein may use fingerprints to represent a selected media data frame i (which may be a frame at or near a significant offset time point), then a Hamming distance may be used as a distance measure to compute corresponding fingerprints in the selected media data frame i and a media data frame at an offset time point away.

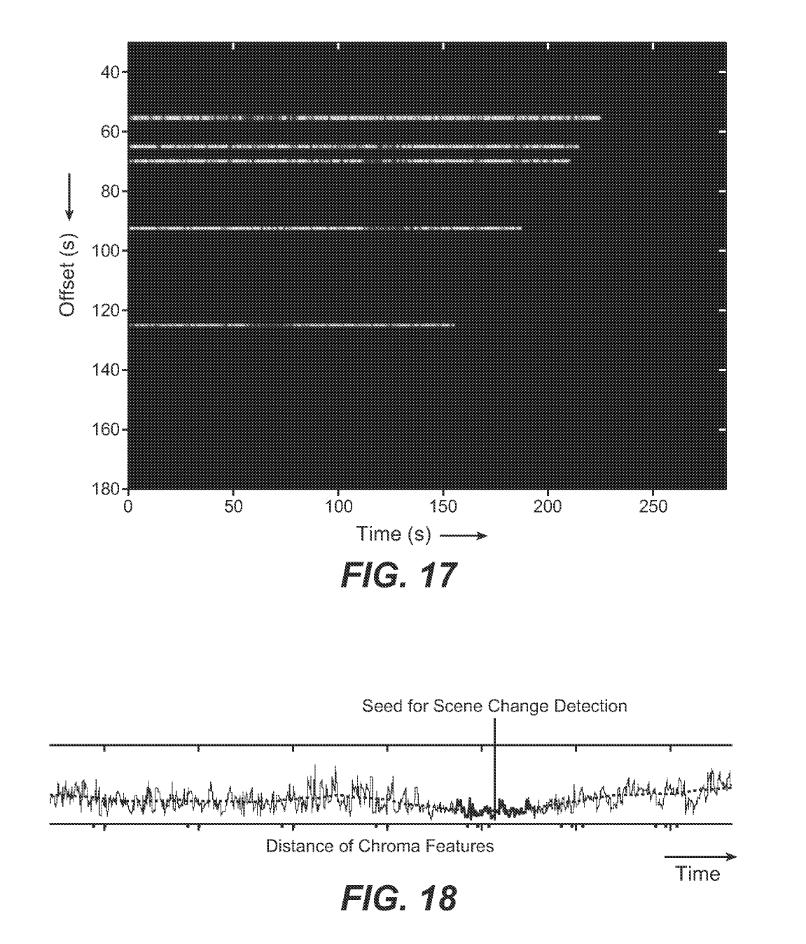

In another example, In an embodiment, if a 12-dimensional chroma vector is used as a feature vector to compute the feature-distance matrix as described herein, then the feature distance may be determined as follows:

$$D ( i , {o}_{k} ) = d ( \underline{c} ( i ) , \underline{c} ( i + {o}_{k} ) ) = \frac{\frac{\underline{c} ( i )}{max ( \underline{c} ( i ) )} - \frac{\underline{c} ( i + {o}_{k} )}{max ( \underline{c} ( i + {o}_{k} ) )}}{\sqrt{12}}$$

Where c(i) denotes the 12 dimensional chroma vector for frame i, and d( ) is a selected distance measure. The computed feature distance matrix (chroma distance matrix) is shown in FIG. 17.

### 6.4. COMPUTE SIMILARITY ROWS

In an embodiment, the resulting chroma distance (feature-distance) values may then be smoothed by the compute-similarity-row block of FIG. 14 with a filter such as a moving average filter of a certain time-wise length, e.g., 15 seconds. In an embodiment, the position of the minimum distance of the smoothed signal may be found as follows:

$$s ( {o}_{k} ) = arg min ( D ( i , {o}_{k} ) )$$

$$over i$$

The finding of the position of the minimum distance of the smoothed signal corresponds to the detection of the position of the media segment of length 15 seconds that is most similar to another media segment of 15 seconds. The two resulting best matching segments are spaced with a given offset oₖ. The position s may be used in the next stage of processing as a seed for the scene change detection. FIG. 18 shows example chroma distance values for a row of the similarity matrix, the smoothed distance and the resulting seed point for the scene change detection.

### 7. REFINEMENT USING SCENE CHANGE DETECTION

In an embodiment, a position in media data such as a song, after having been identified by a feature distance analysis such as a chroma distance analysis as the most likely inside a candidate representative segment with certain media characteristics may be used as a seed time point for scene change detection. Examples of media characteristics for the candidate representative segment may be repetition characteristics possessed by the candidate representative segment in order for the segment to be considered as a candidate for the chorus of the song; the repetition characteristics, for example, may be determined by the selective computations of the distance matrix as described above.

In an embodiment, the scene change detection block of FIG. 14 may be configured in a system herein to identify two scene changes (e.g., in audio) in the vicinity of the seed time point:
a beginning scene change point to the left of the seed time point corresponding to the beginning of the representative segment;
an ending scene change point to the right of the seed time point corresponding to the end of the representative segment.

### 8. RANKING

The ranking component of FIG. 14 may be given several candidate representative segments for possessing certain media characteristics (e.g., the chorus) as input signals and may select one of the candidate representative segments as the output of the signal, regarded as the representative segment (e.g., a detected chorus section). All candidates representative segments may be defined or delimited by their beginning and ending scene change points (e.g., as a result from the scene change detection described herein).

### 9. OTHER APPLICATIONS

Techniques as described herein may be used to detect chorus segments from music files. However, in general the techniques as described herein are useful in detecting any repeating segment in any audio file.

### 10. EXAMPLE PROCESS FLOW

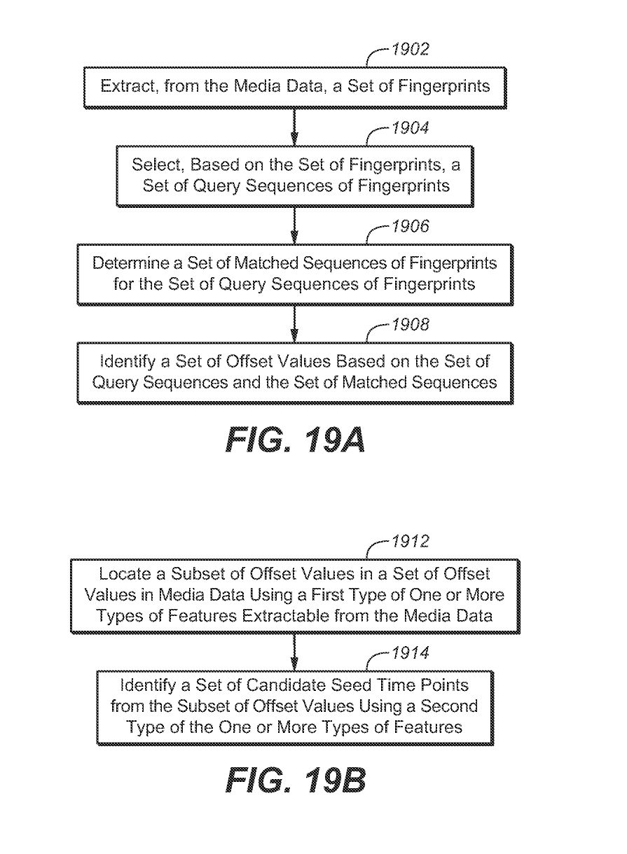

FIG. 19A and FIG. 19B illustrate example process flows according to an example embodiment of the present invention. In an embodiment, one or more computing devices or components in a media processing system may perform one or more of these process flows.

### 10.1. EXAMPLE REPETITION DETECTION PROCESS FLOW—FINGERPRINT MATCHING AND SEARCHING

FIG. 19A depicts an example repetition detection process flow using fingerprints. In block 1902, a media processing system extracts a set of fingerprints from media data (e.g., a song).

In block 1904, the media processing system selects, based on the set of fingerprints, a set of query sequences of fingerprints. Each individual query sequence of fingerprints in the set of query sequences may comprise a reduced representation of the media data for a time interval that begins at a query time.

In block 1906, the media processing system determines a set of matched sequences of fingerprints for the set of query sequences of fingerprints. As used herein, matched sequences include sequences of fingerprints that are similar to a query sequence of fingerprints based on distance-measure based values such as hamming distances. Each individual query sequence in the set of query sequences may correspond to zero or more matched sequences of fingerprints in the set of matched sequences of fingerprints.

In block 1908, the media processing system identifies a set of offset values based on the time position of the best matching sequence for each of the query sequences.

In an embodiment, the set of fingerprints as described herein may be generated by reducing a digital representation of the media data to a reduced dimension binary representation of the media data. The digital representation may relate to one or more of fast Fourier transforms (FFTs), digital Fourier transforms (DFTs), short time Fourier transforms (STFTs), Modified Discrete Cosine Transforms (MDCTs), Modified Discrete Sine Transforms (MDSTs), Quadrature Mirror Filters (QMFs), Complex QMFs (CQMFs), discrete wavelet transforms (DWTs), or wavelet coefficients.

In an embodiment, fingerprints herein may be simple to extract in relation to robust fingerprints required for detecting malicious attacks.

In an embodiment, to determine the set of matched sequences of fingerprints for the set of query sequences of fingerprints, the media processing system may search, in a dynamically constructed database of fingerprints, for matched sequences of fingerprints that match a query sequence of fingerprints.

In an embodiment, the query sequence of fingerprints begins at a specific query time, whereas the dynamically constructed database of fingerprints excludes one or more portions of fingerprints that are within one or more configurable time windows relative to the specific query time.

In an embodiment, to identify a set of offset values based on the set of query sequences and the set of matched sequences, the media processing system uses one or more of histograms constructed from the set of query sequences and the set of matched sequences to determine the set of significant offset values.

In an embodiments, the media processing system uses a low time resolution distance matrix analysis to identify a set of significant offset values. Upon identifying the significant offset value set, an embodiment may perform a higher time resolution chroma distance matrix analysis.

### 10.2. EXAMPLE REPETITION DETECTION PROCESS FLOW—HYBRID APPROACH

FIG. 19B depicts an example repetition detection process flow with a hybrid approach. In block 1912, a media processing system locates a subset of offset values in a set of offset values in media data using a first type of one or more types of features extractable from the media data (e.g., using fingerprint search and matching as described herein). The subset of offset values comprises time difference values selected from the set of offset values based on one or more selection criteria (e.g., using one or more dimensional histograms).

In block 1914, the media processing system identifies a set of candidate seed time points based on the subset of offset values using a second type (e.g., using selective row computation of a feature-distance matrix such as a chroma distance matrix) of the one or more types of features.

In an embodiment, a first type of feature corresponds to lower time resolution chroma features and the second type of feature corresponds to higher time resolution chroma features. An embodiment uses a higher resolution chroma distance analysis to detect candidate seed time point, as discussed in Section 6.3, above. The higher time resolution chroma features are used to identify candidate seed time points at selected subset of offset values. This results in an implementation that is both efficient in memory usage as well as computational expense.

In an embodiment, one or more first features for the first feature type are extracted from the media data. First distance values for a first repetition detection measure (e.g., Hamming distances between bit values of sequences of fingerprints) based on the one or more first features may be computed (e.g., in a sub-process of fingerprint search and matching). The first distance values for the first repetition detection measure may be applied to locate the subset of offset values (e.g., in the sub-process of fingerprint search and matching).

In an embodiment, one or more second features for the second feature type are extracted from the media data. Second distance values for a second repetition detection measure (e.g., chroma distance values in selective rows of a chroma distance matrix) based on the one or more second features may be computed. The second distance values for the second repetition detection measure may be applied to identify the set of candidate seed time points.

In an embodiment, the second type of feature comprises the same type as the first feature type and may differ from the first feature type in relation to their relative transform sizes, transform type, window sizes, window shapes, frequency resolutions, or time resolutions. Performing an analysis on lower time resolution feature in the first stage to identify a set of significant offsets and then performing a higher time resolution analysis on the selected significant offsets (e.g., only) provides significant computational economy.

In an embodiment, at least one of the first repetition detection measure and the second repetition detection measure relates to a measure of similarity or dissimilarity as one or more of: Euclidean distances of vectors, vector norms, mean squared errors, bit error rates, auto-correlation based measures, Hamming distances, similarity, or dissimilarity.

In an embodiment, the first values and the second values comprise one or more normalized values.

In an embodiment, at least one of the one or more types of features herein is used in part to form a digital representation of the media data. For example, the digital representation of the media data may comprise a fingerprint-based reduced dimension binary representation of the media data.

In an embodiment, at least one of the one or more types of features comprises a type of features that captures structural properties, tonality including harmony and melody, timbre, rhythm, loudness, stereo mix, or a quantity of sound sources as related to the media data.

In an embodiment, the features extractable (e.g., derivable) from the media data are used to provide one or more digital representations of the media data based on one or more of: chroma, chroma difference, fingerprints, Mel-Frequency Cepstral Coefficient (MFCC), chroma-based fingerprints, rhythm pattern, energy, or other variants.

In an embodiment, the features extractable from the media data are used to provide one or more digital representations relates to one or more of: fast Fourier transforms (FFTs), digital Fourier transforms (DFTs), short time Fourier transforms (STFTs), Modified Discrete Cosine Transforms (MDCTs), Modified Discrete Sine Transforms (MDSTs), Quadrature Mirror Filters (QMFs), Complex QMFs (CQMFs), discrete wavelet transforms (DWTs), or wavelet coefficients.

In an embodiment, the one or more first features of the first feature type and the one or more second features of the second feature type relate to a same time interval of the media data.

In an embodiment, the one or more first features of the first feature type are used for feature comparison for all offsets of the media data, while the one or more second features of the second feature type are used for a comparison of features for a certain subset of offsets of the media data. In an embodiment, the one or more first features of the first feature type form a representation of the media data for a first time interval of the media data, while the one or more second features of the second feature type forms a representation of the media data for a second different time interval of the media data. In an example, the first time interval is larger than the second different time interval of the media data. In another example, the first time interval covers a complete time length of the media data, while the second time interval covers one or more time portions of the media data within the complete time length of the media data.

In an embodiment, extracting one or more first features (e.g., fingerprints) of the first feature type is simple in relation to extracting one or more second features (e.g., chroma features) of the second feature type, from a same portion of the media data.

As used herein, the media data may comprise one or more of: songs, music compositions, scores, recordings, poems, audiovisual works, movies, or multimedia presentations. The media data may be derived from one or more of: audio files, media database records, network streaming applications, media applets, media applications, media data bitstreams, media data containers, over-the-air broadcast media signals, storage media, cable signals, or satellite signals.

As used herein, the stereo mix may comprise one or more stereo parameters of the media data. In an embodiment, at least one of the one or more stereo parameters relates to: Coherence, Inter-channel Cross-Correlation (ICC), Inter-channel Level Difference (CLD), Inter-channel Phase Difference (IPD), or Channel Prediction Coefficients (CPC).

In an embodiment, the media processing system applies one or more filters to distance values calculated at a certain offset. The media processing system identifies, based on the filtered values, a set of seed time points for scene change detection.

The one or more filters herein may comprise a moving average filter. In an embodiment, at least one seed time point in the plurality of seed time points corresponds to a local minimum in the filtered values. In an embodiment, at least one seed time point in the plurality of seed time points corresponds to a local maximum in the filtered values. In an embodiment, at least one seed time point in the plurality of seed time points corresponds to a specific intermediate value in the statistical values.

In some embodiments in which chroma features are used in techniques herein, the chroma features may be extracted using one or more window functions. These window functions may be, but are not limited to, musically motivated, perceptually motivated, etc.

As used herein, the features extractable from the media data may or may not relate to a tuning system of 12 equal temperaments.

Thus, an embodiment of the present invention functions to detect repetition in media data with low complexity. A subset of offset time points is located in a set of offset time points in media data using a first type of one or more types of features, which are extractable from the media data. The subset of offset time points comprise time points that are selected from the set of offset time points based on one or more selection criteria. A set of candidate seed time points is identified from the subset of offset time points using a second type of the one or more types of features. The example process may be performed with one or more computing systems, apparatus or devices, integrated circuit devices, and/or media playout, reproduction, rendering or streaming apparatus. The systems, devices, and/or apparatus and/or may be controlled, configured, programmed or directed with instructions or software, which are encoded or recorded on a computer readable storage medium.

An example embodiment may perform one or more additional repetition detection processes, which may involve somewhat more complexity. For example, in an application wherein computational costs or latency may have less significance or to achieve verification of the low complexity repetition detection, an example embodiment may further detect repetition in media with derivation (e.g., extraction) of one or more media fingerprints from component features of the media content, or with multiple (e.g., a second) offset time point subset.

### 11. IMPLEMENTATION MECHANISMS—HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

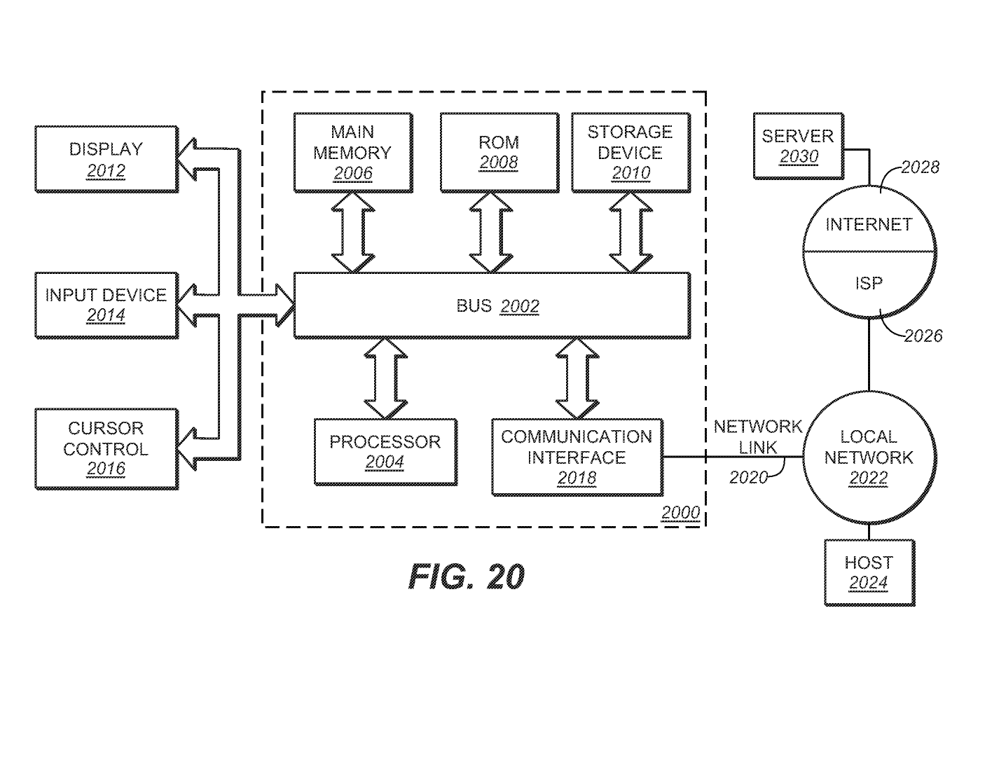

For example, FIG. 20 is a block diagram that depicts a computer system 2000 upon which an embodiment of the invention may be implemented. Computer system 2000 includes a bus 2002 or other communication mechanism for communicating information, and a hardware processor 2004 coupled with bus 2002 for processing information. Hardware processor 2004 may be, for example, a general purpose microprocessor.

Computer system 2000 also includes a main memory 2006, such as a random access memory (RAM) or other dynamic storage device, coupled to bus 2002 for storing information and instructions to be executed by processor 2004. Main memory 2006 also may be used for storing temporary variables or other intermediate information during execution of instructions to be executed by processor 2004. Such instructions, when stored in storage media accessible to processor 2004, render computer system 2000 into a special-purpose machine that is customized to perform the operations specified in the instructions.

Computer system 2000 further includes a read only memory (ROM) 2008 or other static storage device coupled to bus 2002 for storing static information and instructions for processor 2004. A storage device 2010, such as a magnetic disk or optical disk, is provided and coupled to bus 2002 for storing information and instructions.

Computer system 2000 may be coupled via bus 2002 to a display 2012 for displaying information to a computer user. An input device 2014, including alphanumeric and other keys, is coupled to bus 2002 for communicating information and command selections to processor 2004. Another type of user input device is cursor control 2016, such as a mouse, a trackball, or cursor direction keys for communicating direction information and command selections to processor 2004 and for controlling cursor movement on display 2012. This input device typically has two degrees of freedom in two axes, a first axis (e.g., x) and a second axis (e.g., y), that allows the device to specify positions in a plane. Computer system 2000 may be used to control the display system (e.g., 100 in FIG. 1).

Computer system 2000 may implement the techniques described herein using customized hard-wired logic, one or more ASICs or FPGAs, firmware and/or program logic which in combination with the computer system causes or programs computer system 2000 to be a special-purpose machine. According to one embodiment, the techniques herein are performed by computer system 2000 in response to processor 2004 executing one or more sequences of one or more instructions contained in main memory 2006. Such instructions may be read into main memory 2006 from another storage medium, such as storage device 2010. Execution of the sequences of instructions contained in main memory 2006 causes processor 2004 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 2010. Volatile media includes dynamic memory, such as main memory 2006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 2002. Transmission media can also take the form of acoustic or light waves, such as those generated during radio-wave and infra-red data communications.

Various forms of media may be involved in carrying one or more sequences of one or more instructions to processor 2004 for execution. For example, the instructions may initially be carried on a magnetic disk or solid state drive of a remote computer. The remote computer can load the instructions into its dynamic memory and send the instructions over a telephone line using a modem. A modem local to computer system 2000 can receive the data on the telephone line and use an infra-red transmitter to convert the data to an infra-red signal. An infra-red detector can receive the data carried in the infra-red signal and appropriate circuitry can place the data on bus 2002. Bus 2002 carries the data to main memory 2006, from which processor 2004 retrieves and executes the instructions. The instructions received by main memory 2006 may optionally be stored on storage device 2010 either before or after execution by processor 2004.

Computer system 2000 also includes a communication interface 2018 coupled to bus 2002. Communication interface 2018 provides a two-way data communication coupling to a network link 2020 that is connected to a local network 2022. For example, communication interface 2018 may be an integrated services digital network (ISDN) card, cable modem, satellite modem, or a modem to provide a data communication connection to a corresponding type of telephone line. As another example, communication interface 2018 may be a local area network (LAN) card to provide a data communication connection to a compatible LAN. Wireless links may also be implemented. In any such implementation, communication interface 2018 sends and receives electrical, electromagnetic or optical signals that carry digital data streams representing various types of information.

Network link 2020 typically provides data communication through one or more networks to other data devices. For example, network link 2020 may provide a connection through local network 2022 to a host computer 2024 or to data equipment operated by an Internet Service Provider (ISP) 2026. ISP 2026 in turn provides data communication services through the world wide packet data communication network now commonly referred to as the “Internet” 2028. Local network 2022 and Internet 2028 both use electrical, electromagnetic or optical signals that carry digital data streams. The signals through the various networks and the signals on network link 2020 and through communication interface 2018, which carry the digital data to and from computer system 2000, are example forms of transmission media.

Computer system 2000 can send messages and receive data, including program code, through the network(s), network link 2020 and communication interface 2018. In the Internet example, a server 2030 might transmit a requested code for an application program through Internet 2028, ISP 2026, local network 2022 and communication interface 2018. The received code may be executed by processor 2004 as it is received, and/or stored in storage device 2010, or other non-volatile storage for later execution.

### 12. EQUIVALENTS, EXTENSIONS, ALTERNATIVES AND MISCELLANEOUS

An example embodiment of the present invention is thus described in relation to low complexity detection of repetition in media data. A subset of offset values is selected from a set of offset values in media data using a first type of one or more types of features, which are extractable from (e.g., derivable from components of) the media data. The subset of offset values comprise values that are selected from the set of offset values based on one or more selection criteria. A set of candidate seed time points is identified based on the subset of offset values using a second type of the one or more types of features. The example process may be performed with one or more computing systems, apparatus or devices, integrated circuit devices, and/or media playout, reproduction, rendering or streaming apparatus. The systems, devices, and/or apparatus and/or may be controlled, configured, programmed or directed with instructions or software, which are encoded or recorded on a computer readable storage medium.

An example embodiment may perform one or more additional repetition detection processes, which may involve somewhat more complexity. For example, in an application wherein computational costs or latency may have less significance or to achieve verification of the low complexity repetition detection, an example embodiment may further detect repetition in media with derivation (e.g., extraction) of one or more media fingerprints from component features of the media content, or with multiple (e.g., a second) offset time point subset.

In the foregoing specification, example embodiments of the invention have been described with reference to numerous specific details, which may vary from implementation to implementation. Thus, the sole and exclusive indicator of what the embodiments of the invention comprise, and is intended by Applicants to comprise the embodiments of the invention, is the set of claims that issue from this application, in the specific form in which such claims issue, including any subsequent correction. Any definitions that are expressly set forth herein for terms contained in such claims shall govern the meaning of such terms as used in the claims. Thus, no limitation, element, property, feature, advantage or attribute that is not expressly recited in a claim should limit the scope of such claim in any way. The specification and drawings are, accordingly, to be regarded in an illustrative rather than a restrictive sense.

1-43. (canceled)

44. A method for repetition detection in media data, comprising:
selecting a subset of offset values in a set of offset values in media data using a first type of one or more types of features extractable from the media data, the subset of offset values comprising values selected from the set of offset values based on one or more selection criteria; wherein selecting comprises extracting, from the media data, one or more first features for the first feature type;
computing first distance values for a first repetition detection measure based on the one or more first features;
applying the first distance values for the first repetition detection measure to select the subset of offset values;
identifying a set of candidate seed time points based on similarity/distance analysis of a second type of the one or more types of features at the subset of offset values;
wherein identifying comprises:
extracting, from the media data, one or more second features for the second feature type; wherein the second features type and the first feature type differ in relation to one or more of time resolution or frequency resolution;
computing second distance values for a second repetition detection measure based on the one or more second features; and
applying the second distance values for the second repetition detection measure to identify the set of candidate seed time points.

45. The method as recited in claim 44 wherein the second feature type is derived or extracted from a representation of a signal, which relates to the media data, using one or more of: a transform size, a transform type, a window size, a window shape, a frequency resolution, or a time resolution.

46. The method as recited in claim 44, wherein the first feature type further comprises a set of fingerprints that are derived from the media data, wherein the method further comprises:
selecting, based on the set of fingerprints, a set of query sequences of fingerprints, each individual query sequence of fingerprints in the set of query sequences comprises a reduced representation of the media data for a time interval that begins at a query time;
determining a set of matched sequences of fingerprints for the set of query sequences of fingerprints, each individual query sequence in the set of query sequences corresponds to zero or more matched sequences of fingerprints in the set of matched sequences of fingerprints;
identifying a set of offset values based on the set of query sequences and the set of matched sequences;
wherein the method is performed by one or more computing devices.

47. The method as recited in claim 46, wherein determining a set of matched sequences of fingerprints for the set of query sequences of fingerprints comprises searching, in a dynamically constructed database of fingerprints, for matched sequences of fingerprints that match a query sequence of fingerprints.

48. The method as recited in claim 46, wherein identifying a set of offset values based on the set of query sequences and the set of matched sequences comprises using one or more of histograms constructed from the set of query sequences and the set of matched sequences to determine the set of significant offset values.

49. The method as recited in claim 44, wherein at least one of the first repetition detection measure and the second repetition detection measure relates to one or more of: Euclidean distances of vectors, vector norms, mean squared errors, bit error rates, auto-correlation based measures, Hamming distances, similarity, or dissimilarity.

50. The method as recited in claim 44, wherein the first values and the second values comprise one or more normalized values.

51. The method as recited in claim 44, wherein at least one of the one or more types of features is used to form in part a digital representation of the media data.

52. The method as recited in claim 44, wherein at least one of the one or more types of features comprises a type of features that captures structural properties, tonality including harmony and melody, timbre, rhythm, loudness, stereo mix, or a quantity of sound sources as related to the media data.

53. The method as recited in claim 44, wherein the features extractable from the media data are used to provide one or more digital representations of the media data based on one or more of: chroma, chroma difference, differential chroma features, fingerprints, Mel-Frequency Cepstral Coefficient (MFCC), chroma-based fingerprints, rhythm pattern, energy, or other variants.

54. The method as recited in claim 44, wherein the one or more first features of the first feature type and the one or more second features of the second feature type relate to a same time interval of the media data.

55. The method as recited in claim 44, wherein the one or more first features of the first feature type form a representation of the media data for a first time interval of the media data, while the one or more second features of the second feature type forms a representation of the media data for a second different time interval of the media data.

56. The method as recited in claim 44, wherein extracting the one or more first features of the first feature type is simple in relation to extracting the one or more second features of the second feature type, from a same portion of the media data.

57. The method as recited in claim 44, wherein computing distance values for the one or more first features of the first feature type is simple in relation to computing distance values for the one or more second features of the second feature type, from a same portion of the media data.

58. The method as recited in claim 44, wherein the media data comprises one or more of: songs, music compositions, scores, recordings, poems, audiovisual works, movies, or multimedia presentations.

59. The method as recited in claim 44, further comprising deriving the media data from one or more of: audio files, media database records, network streaming applications, media applets, media applications, media data bitstreams, media data containers, over-the-air broadcast media signals, storage media, cable signals, or satellite signals.

60. The method as recited in claim 44, further comprising:
applying one or more filters to distance values at one or more offsets;
identifying, based on the filtered values, a set of seed time points for scene change detection.

61. The method as recited in claim 44, further comprising:
applying one or more filters to distance values at one or more time intervals for one or more offsets;
identifying, based on the filtered values, a set of seed time points for scene change detection.

62. The method as recited in claim 44, further comprising extracting one or more chroma features using one or more window functions.

63. The method as recited in claim 44, further comprising extracting one or more of the chroma features using one or more musically motivated window functions.
